(19) United States
(12) Patent Application Publication
(10) Pub. No.: US 2005/0289650 A1
(43) Pub. Date: Dec. 29, 2005

(54) Network node security analysis method

(75) Inventor: Georgios Kalogridis, Bristol (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/152,226

(22) Filed: Jun. 15, 2005

(30) Foreign Application Priority Data
Jun. 24, 2004 (GB) 0414213.9

(51) Int. Cl. G06F 11/00

(52) U.S. Cl. 726/22

(57) ABSTRACT

The present invention relates to analysing network nodes such as web servers using mobile software agents, and network nodes for interacting with said agents. The present invention provides a system of disseminating two or more assessment agents to a target network node in an insecure network, and retrieving said agents following interaction with the node. The agents are software based mobile agents and are arranged such that they are associated with different sources or transmitters. This is achieved by forwarding the agents to a plurality of trusted nodes in the network which each modify the received agent's code in order to show the trusted node as the source of the agent, and forwarding the agent towards the target node. The system having retrieved the plurality of (further) modified agents then analyses their different interactions with the target node in order to determine a trust level for said target node.

### FIELD OF THE INVENTION

The present invention relates to methods of analysing network nodes such as web servers using mobile software agents, and the network nodes themselves which interact with said agents.

### BACKGROUND OF THE INVENTION

Mobile software agents are executable files containing software code which can be executed by a host computer or node in a network. The agent is forwarded from one node to another in the network using standard network transport protocols such as TCP/IP in the Internet. The file containing the code is usually restricted to a secure area of the host such that it has only restricted access to the host's data and functions. For example a Java Applet may be loaded into a Java sandbox as illustrated in FIG. 1, from where the Applet is executed and interacts with the host in a well defined and restricted way.

Such mobile agents are “legitimate” in the sense that they are intended for interacting with the host in a defined way, and the host expects to deal with such agents. Examples of applications for such agents include a price comparison agent which “visits” a number of on-line retailer sites or nodes and requests a price for a particular item. The agent returns to its originator, for example an on-line shopper with prices from a number of different retailers.

Mobile agents of this sort contrast with viruses and other “illegitimate” agents such as Ad-ware programs which attempt to access the host itself rather than remain in the secure area (eg the sandbox). Viruses can then steal secure information from the host, for example personal financial details, cause the host to act in an unintended way for example email spam, or simply corrupt the host's systems so that it no longer functions properly. Ad-ware similarly gains access to some of the host's data such as in particular its history of web browsing in order to provide information on the habits of a person associated with the host which might be of interest to marketers. In a further example pop-up ad programs can be arranged to present on-screen windows dependent on what activity the user is engaged in on the computer.

Broadly speaking there are two security issues that need to be tackled: The first one is thwarting passive or active attacks and the second is at least detecting attacks. Attacks can be grouped in four distinct categories: Agent against Platform; Platform against Agent; Agent against Agent; and Third Parties against Agent or Platform.

For the first, third and forth issues, contemporary techniques offer a wide range of services which offer satisfactory solutions. For example there are already available Java Mobile Agent Security development kits that are able to authenticate incoming agents, restrict them in sandboxes and limit their functionality with fine grained access control policies. For more details see Karjoth G., Lange D. B., Oshima, M. “A security model for Aglets”, IEEE Internet Computing, Volume 1, Issue 4, July-August 1997

The most challenging one is the second, since the platform will always be the agent's host and will be able to theoretically treat it in any way. There are diverse solutions for this problem (tamper-proof hardware, code obfuscation and encrypted functions, strategic division of one agent to multiple ones, etc) that nevertheless cannot address the problem in a satisfactory way because they either depend on hardware modules, or still have unresolved technical problems, or they depend too much on the notion of trust and the idea that the host should always adhere to an implied policy.

Background information and state-of-the-art techniques for the security issues of the challenging and promising Mobile Agent Technology can be derived from the IST-Shaman project whose documents are publicly available at www.ist-shaman.org

A problem with legitimate agents is that they are at the mercy of the host which executes them, as ultimately the host may simply carry out the functions requested by the agent as expected, or it may manipulate the agent. Such manipulation might include reading data contained within the agent which is intended to remain private, for example quotes from other on-line retailers, and/or the source address or identity of the agent's user. This identity information can then be misused for example by forwarding spam to the user's email address. Even more inappropriate behaviour might include reading the quotes from its competitor on-line retailers and providing a quote less than these, or possibly even changing the other quotes so that they are higher.

Autonomous mobile agents, apart from getting price quotes or other information back for further analysis, might also be able to complete a transaction remotely and completely independently by fully representing and theoretically satisfying the client's instructions. For example to get a cheap ticket automatically, an agent may be instructed to visit several on-line stores in order to purchase a ticket, for example a direct flight. This ticket should be the cheapest, for example less than £150 (without giving personal information) or giving personal information (eg email address and permission to be sent offers) if the price is good enough (eg. £100). The agent then makes the purchase completely autonomously. The hosts should never access this logic, nor the private data that the agent will carry, however there is clearly a possibility for abuse.

Because the host or node can re-write the code of the agent, there is no clear way of detecting whether the host node has acted properly. Currently it is typically just assumed that these nodes can be trusted. However some attempts have been made to try to ensure good behaviour, or at least detect misbehaviour by hosts. For example agents may use encrypted functions or be divided into multiple sub-agents, as described for example in Wayne Jansen, Tom Karygiannis, NIST Special Publication 800-19: Mobile Agent Security, National Institute of Standards and Technology, August 1999.

### SUMMARY OF THE INVENTION

In general terms in one aspect the present invention provides a system of disseminating two or more assessment agents to a target network node in an insecure network, and retrieving said agents following interaction with the node. The agents are software based mobile agents and are arranged such that they are associated with different sources or transmitters. This is achieved by forwarding the agents to a plurality of trusted nodes in the network, which each modify the received agent's code in order to show the trusted node as the source of the agent, before forwarding the agent towards the target node.

Preferably the ultimate destination associated with the modified agent is another or second trusted node, the first trusted node indicating to the second trusted node to expect the modified agent. The second trusted node on receiving the agent, again (further) modifies the agent with a destination address corresponding to the original source of the agent; and then forwards the further modified agent to this original source.

The system having retrieved the plurality of (further) modified agents then analyses their different interactions with the target node in order to determine a trust level for said target node.

In particular in one aspect there is provided a trust assessment system for assessing a target node in a network having a number of nodes according to claim 1.

In particular in another aspect there is provided a method of assessing a target node in a network having a number of nodes, the method according to claim 15.

In particular in another aspect there is provided a trusted node for a trust assessment system for assessing a target node in a network having a number of nodes, the trusted node according to claim 12 or 14.

In particular in another aspect there is provided an assessment node for a trust assessment system for assessing a target node in a network having a number of nodes, the assessment node comprising means for issuing a plurality of software agents for assessing the target node, and receiving returned agents following their interaction with the target node. The node may compare or otherwise analyse the returned agents in order to assign a trust parameter to the target node. For example if the agents return with unexpected modifications to their data from the target node this may indicate a lower level of trust.

Preferably the assessment node issues the agents to a number of trusted node coupled to the network, the trusted nodes changing an identifier in the agents associated with the assessment node for their own identifier.

In general terms in another aspect the present invention provides a system of disseminating two or more assessment agents to a target network node in an insecure network, and retrieving said agents following interaction with the node. The agents are software based mobile agents and are arranged such that they are destined for different final destinations. This is achieved by forwarding the agents with different routing information such that they are forwarded to different final destinations which are one of a plurality of trusted nodes in the network which each modify the received agent's code in order to forward the agent towards an assessment node.

Preferably the agents are initially also forwarded from an assessment node to a plurality of trusted nodes in the network which each modify the received agent's code in order to show the trusted node as the source of the agent, and forwarding the agent towards the target node.

### BRIEF DESCRIPTION OF THE DRAWINGS

Embodiments will now be described, by way of example only and without intending to be limiting, in which:

FIG. 1 shows a schematic of a network node host system;

FIG. 2 shows a network of nodes;

FIG. 3 shows a system according to an embodiment;

FIG. 4 shows a schematic of a software agent;

FIG. 5 is a flow chart showing operation of the trusted node A of FIG. 3;

FIG. 6 is a flow chart showing operation of the trusted node B of FIG. 3;

FIG. 7 is a flow chart showing operation of the assessment node D of FIG. 3; and

FIG. 8 shows a schematic of a network of networks according to an embodiment; and

FIG. 9 shows a system of routing mobile agents according to an embodiment.

### DETAILED DESCRIPTION

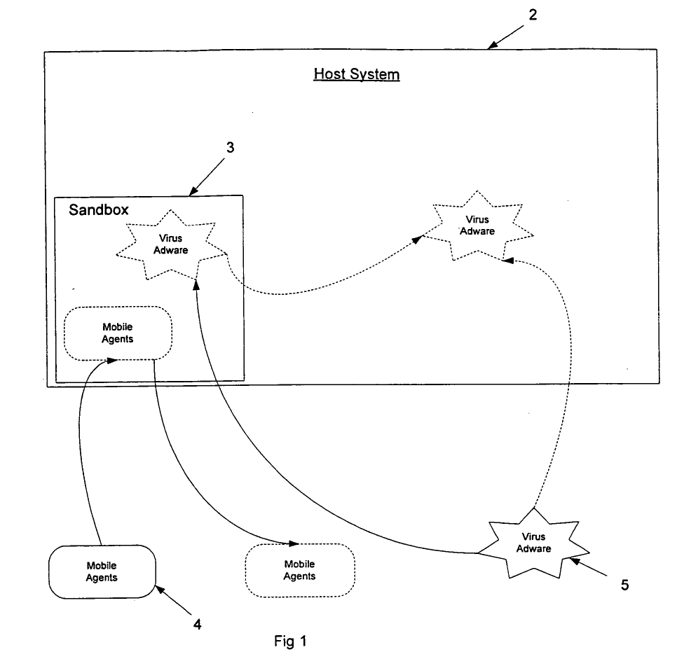

FIG. 1 shows schematically a host system of a network node in a network such as the Internet for example. The node comprises a host system 2 having hardware and software resources to communicate with other nodes and to process those communications. The host system includes a secure area 3 such as a Java Sandbox to control the processing of software sent by other nodes and to limit its access to the rest of the host system 2. The software sent by other nodes typically comprises mobile agents 4 in the form of computer code (eg Java byte code) in a file (eg Java Applet) which can be executed by the host system in the secure area 3 of the node.

These mobile agents 4 have many uses including gathering data from the node (eg an on-line retailer) for a client, such as an on-line shopper. The agent 4 contains code in a known format (eg Java) which when executed on the secure platform 3 will request information or other services from the host 2. These requests are passed to the rest of the host system 2 if legitimate, and the host 2 supplies the requested information, for example a price for a specified product. The agent 4 also typically includes further destinations and the host then forwards the file with the extra data to its next destination where the process is repeated on another node. This forwarding is achieved by the host responding to the agent's request to be sent to another destination.

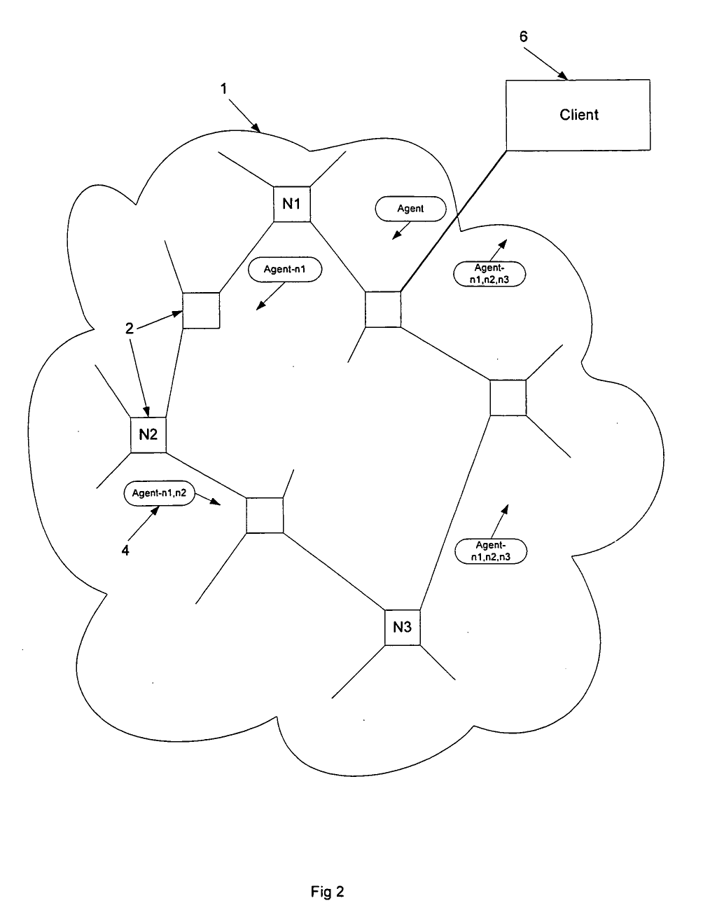

FIG. 2 illustrates a mobile agent 4 moving about a network 1 of interconnected nodes 2. The agent 4 is sent by a client 6 onto the network 1 and includes target addresses N1, N2, and N3 for specific nodes 2 the client 6 wants to get data from. The agent 4 is passed about the other nodes 2 in the network 1 in order to find the target nodes N as is known. Each time the agent 4 interacts with a target node (eg N1), it adds data (eg n1) from that node to its own code or file. After all the intermediate addresses in the agent have been visited, the agent 4 is sent back to its original destination—the client 6. In this way, the mobile agent 4 may retrieve pricing or other data from a number of specified nodes (N1,N2,N3), eventually returning to its final destination (the original client) with associated data (n1,n2,n3).

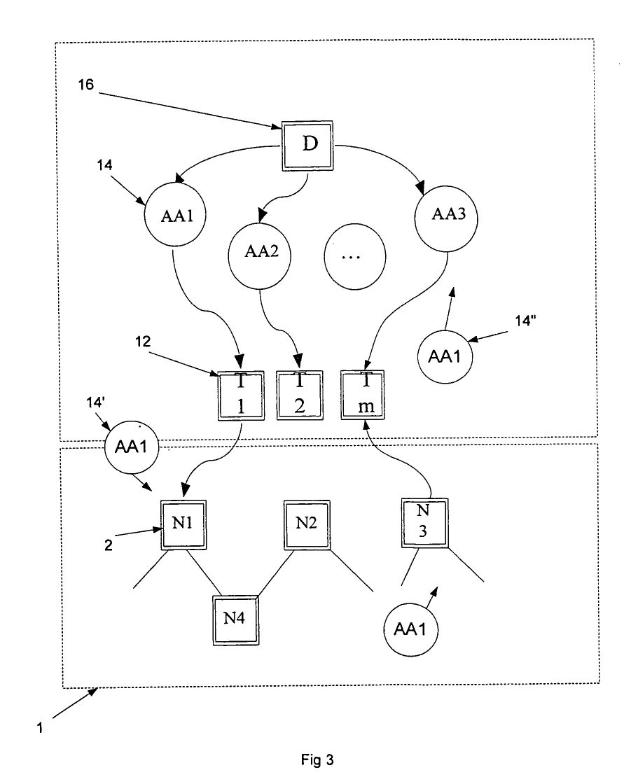

FIG. 3 illustrates an embodiment in which a client 16 is coupled to a number of trusted nodes 12 (T1, T2, . . . Tn). Each of the trusted nodes T is in turn coupled to a network 1 of untrusted nodes 2 (such as the Internet for example) similar to that shown in FIG. 2, and including a number of target nodes N1, N2, N3 from which data is sought. The client device 16 issues a number of software assessment agents 14, the agents being distributed to a number of the trusted nodes 12. The actual number of agents 14 issued may range from three, one for each of the trusted nodes shown, to thousands split between the trusted nodes 12.

The trusted nodes 12 receive the agents 14 and modify their source or origin details or identifiers such that they are no longer associated with the client 16, but are now associated with the trusted nodes 12 (T1, T2 or T3). These modified agents, indicated as 14′, are then sent onto the network 1 and interact with the nodes 2 as described above. The agents 14′ will accumulate data (n1,n2,n3) from the target nodes N1, N2 and N3 as before, and return to a final destination with all this accumulated data.

The final destination is contained within the agent 14′, and will be utilised when all intermediate addresses have been visited as is known. The final destination should preferably not be the client's address (D), as this may expose the agent 14′ as an assessment agent rather than a standard m-commerce agent such as a price gopher for example. The agent 14′ may use as its final destination the trusted node 12 address or identity (T1, T2, or T3) from which it was issued onto the network 1, or it may use the destination identifier of another trusted node 12 (T2, T3, or T1). In these cases the trusted node 12 issuing the modified agent 14′ onto the network 1 will have to modify the agent's final destination address or identifier as well as its source or origin identifier.

In the case where the agent 14′ issues from one trusted node 12 (T1) but returns to another trusted node (T3), the issuing trusted node (T1) also notifies the receiving trusted node (T3) to expect the agent 14′.

When a modified agent 14′ is received by a trusted node 12 (T2 or T3 say), the node 12 further modifies the agent 14′ to change its final destination address or identifier from the current trusted node 12 (T2 or T3) to the client device 16 (D). The further modified agent—indicated as 14″—is then forwarded to the client device 16.

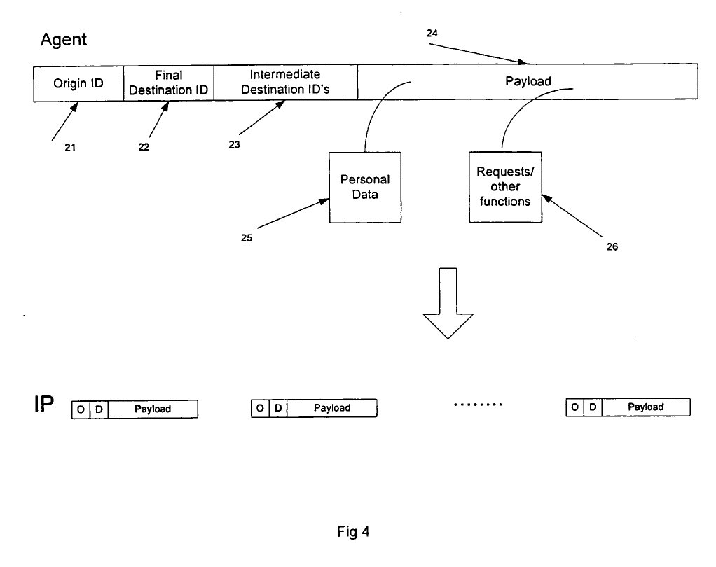

These processes are described in more detail below, but first a schematic of an assessment software agent (14, 14′ or 14″) is shown in FIG. 4. The agent 14 includes an origin or source ID field or part 21, a final destination ID field or part 22, a number of intermediate node ID's 23, and a payload 24. The payload 24 includes personal data 25 such as a name, address, email address, various certificates, financial information, and other information associated with a person or client; as well as the agent's executable code. In the assessment scenario, this information will be virtual in the sense that it is not associated with a real person but an emulated identity sufficient for the recipient hosts 2 to identify the agent 14 as from a real client, in order to ensure that the hosts behave as if the agent was from a real person. The agent 14 may then be transported across the network 1 in any manner, for example by being split into smaller IP packets and forwarded across the Internet using the TCP protocol for example as indicated. Agent's themselves should conform to agreed formats in order to ensure interoperability as is known. Various well known agent platforms exist such as Java applets and aglets. The internal structure of the agent however can be organised in any suitable manner, ensuring interoperability by utilising generic interface functions such as READ( ). The particular agent structure of FIG. 4 is merely illustrative. More generally the agent will contain code and data—the data can be structured in any abstract manner and the code could be dynamic. For example the destination ID on the next of final node may be determined dynamically rather than statically predetermined.

The agent structure should preferably be a commonly used structure so that it looks normal or at least not abnormal in order to minimise the probability of making the target host suspicious. The Foundation for Intelligence Physical Agents (FIPA) provides specifications for generic agent technologies that maximise interoperability—see www.fipa.org

Thus in the embodiment described above the trusted node 12 receives the initial agent 14 and modifies its origin field 21 to now hold the trusted node's identity (T1); and preferably also the final destination field 22 to include one of the address or identity of one of the other trusted nodes 12 (T3).

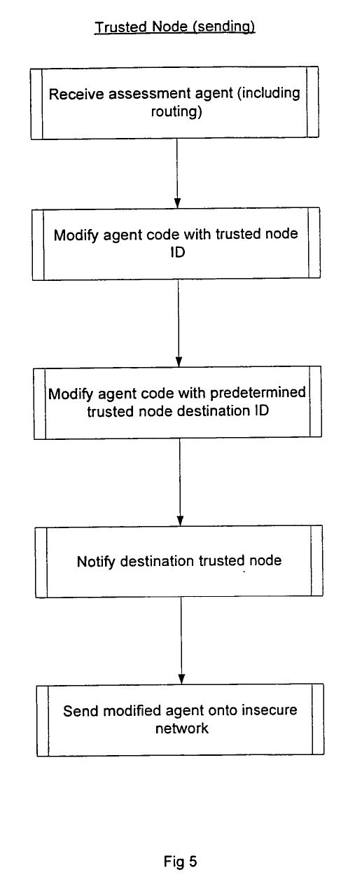

FIG. 5 shows a flow chart according to an embodiment for a trusted node (eg T1) which first receives the agent 14 from the client 16. The trusted node T1 receives the agent 14, including its routing via the intermediate address fields 23, from the client device 16. The node T1 then modifies the origin field 21 of the agent 14, replacing the clients address (D) with its own address (T1). The node T1 then modifies the final destination identifier field 22 by replacing the client address (D) with the address of another trusted node (T3). Which final destination address should be used may be indicated by the client 16, for example in a separate message or in a special field in the agent 14 which is then removed by the trusted node T1. As a further alternative, the agent 14 may be received with the intended destination trusted node T3 already in the final destination field 22.

The trusted node T1 then issues a notification to the other (receiving) trusted node T3 which is to serve as the final destination for the modified agent 14′. The notification may simply include the modified agent's origin identifier (now T1), perhaps along with a transmittal time in order for the destination trusted node T3 to be able to recognise the modified agent 14′. Agents will alos typically have their own ID or Name as well as a Certificate or passport or some kind of identification token. The modified agent 14′, containing the modified origin identifier (T1) and modified final destination identifier (T3), is then transmitted onto the network 1.

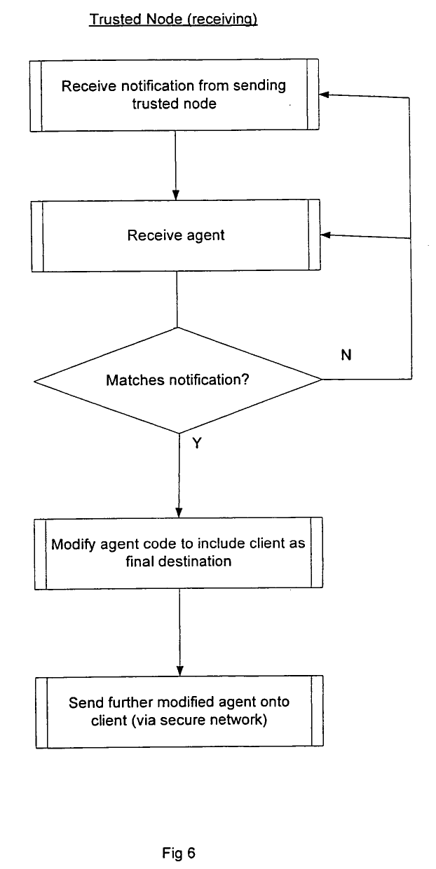

FIG. 6 shows a flow chart according to an embodiment for a trusted node (eg T3) which receives the modified agent 14′ from the network 1. The node T3 receives the modified agent 14′ which will also contain data retrieved from the various target nodes N1, N2, and N3 it was intended to interrogate. The node T3 then determines whether it matches any of its notifications, for example the one issued by T1 above. This may be achieved simply be determining the origin identifier of the agent 14′, which will include the sending trusted node's address T1. The identity of the agent 14′ may additionally be confirmed by comparing the time of receiving the notification with the time of receiving the agent 14′. Also the agent itself may have a unique identifier which the sending trusted node T1 forwarded with its notification. Upon matching, the agent 14′ has its final destination field 22 further modified to include the address (D) of the client device 16. The further modified agent 14″ is then forwarded to the client device 16, which may be in a different (trusted) network for example.

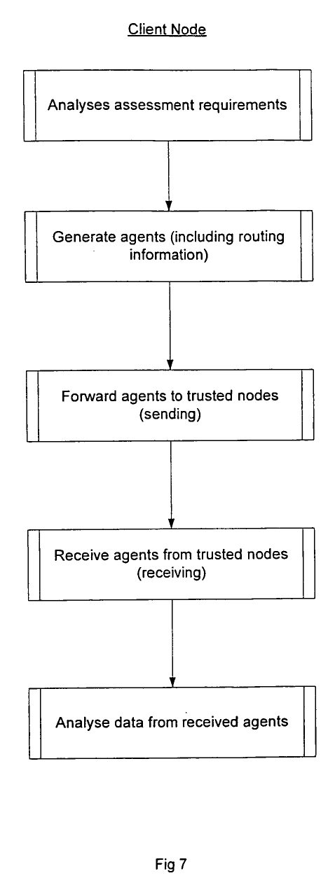

FIG. 7 shows a flow chart for an assessment node or client device 16. The client device 16 formulates an assessment strategy for forwarding a number of software agents 14 from different trusted nodes 12 to various target nodes N within an insecure network 1. This might be as simple as one copy of an agent 14′ being issued from each trusted node T1, T2 and T3 towards a target node N1; with each agent 14′ then returning to the trusted node which issued it, and from there back to the client device where the data gathered from the three agents (14″) can be compared and analysed.

More sophisticated mechanisms can also be employed, for example multiple agents 14′ issuing from a large number of trusted nodes 12, and being routed using different paths so that they interact with the target node(s) N1 (and N2 and N3) in different ways and eventually find their way back to the client device 16. Such a sophisticated routing scheme more effectively disguises the fact that the agents 14′ are all from the client device 16, or are in any way related. The target nodes N are then more likely to treat them as normal e-commerce agents and behave normally. As assessment of normal target node behaviour is the goal, these more complicated arrangements, whilst more expensive are also likely to be more accurate.

The data retrieved from the agents can then be analysed, for example this may simply be averaging a price and determining the standard deviation to indicate how much the target node N varies the price depending on who it thinks the agents' represent. Again more sophisticated analysis is also possible as described further below.

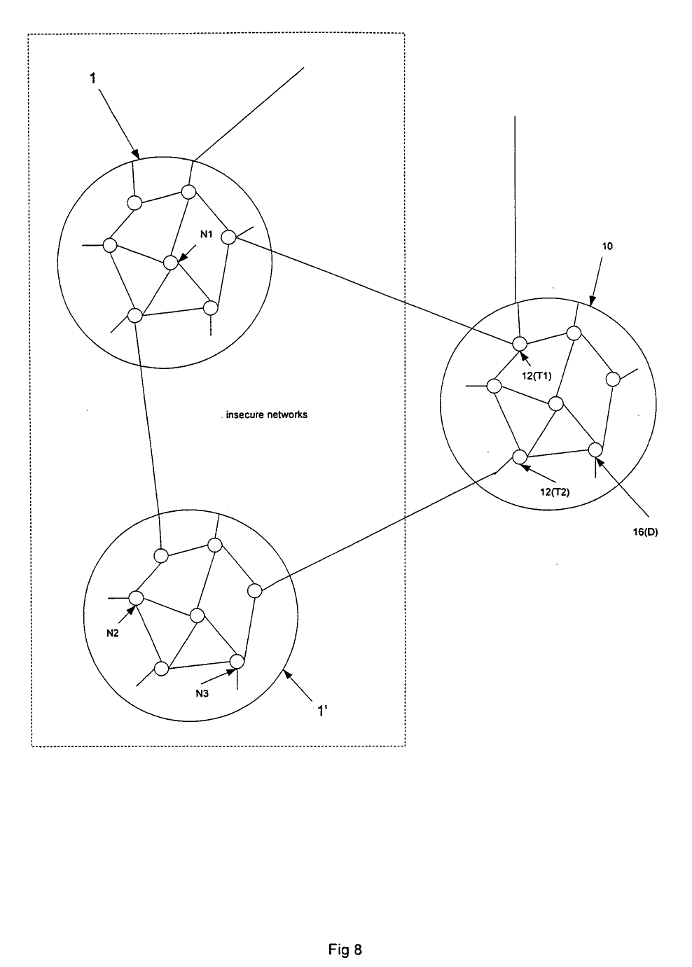

FIG. 8 shows a schematic of an embodiment having a large trusted network 10 comprising the client device or assessment node 16 and a number of trusted nodes 12 coupled to other insecure networks 1 and 1′ comprising various target nodes N1,N2,N3. It can be seen that a large variety of routing schemes are possible in order to disguise any associations between the agents 14′ sent from the secure network 10.

The embodiments provide the means to evaluate trust in remote and possibly hostile environments without having the target hosts (N) know anything about this. In this way the assessment agents 14′ have the ability to extract the target hosts' genuine behaviour and real-life characteristics which could be honest or dishonest. For example this assessment might determine the degree to which a host complies with its policies or more specifically with its responsibilities to respect clients' security demands.

The assessment agent preferably doesn't carry special security code or appear in any way to be an assessment or enforcement agent, and on the contrary it should preferably behave like a normal e-commerce agent, for example just fetching information back to a secure location for further processing. In this way the assessment agent arrangement aims to: 1) make target hosts N incapable of deciding whether they are dealing with an assessment scenario or not; 2) extract misbehaviours by using the agents 14′ like bait to encourage misbehaviour; and 3) analyse feedback to find out which target nodes have misbehaved and build up probabilistic reputation profiles

It is possible for just one client device 16 to independently run the assessment agent software using a small number of trusted nodes 12 for a low quality security prediction. However it is envisaged that the agents can leverage professional security services if a large network of allies can be employed. For example Assessment Agency specialist software providers could employ hundreds of trusted platforms 12. Assessment agents 14′ have the ability to exploit this force for better distributed intelligence and better results.

In a simple example an assessment agent migrates to a specific (target) host N in order to evaluate its performance and behaviour regarding offered e-commerce services. These e-commerce servers could adhere to a certified public policy. This policy could for example demand that hosts never attempt to read data that an incoming agent 14′ might maintain or manipulate the coding part that determines the agent's behaviour.

Using an embodiment, the target host N will be incapable of distinguishing between assessment agents 14′ and normal e-commerce agents. Alternatively or additionally assessment agents might not be disguised as normal e-commerce agents, but appear as assessment or enforcement agents but hide their identity and their origin, and simply bear (if necessary) certificates that will enable them to request to commence a few security queries. Ideally the host should not demonstrate any special behaviour with the assessment agents (either as assessment agents or hidden as normal e-commerce agents).

Having received as much feedback as possible the originator (client 16) performs various security assessments and calculates or refines final answers to fill in a security assessment form. For example this security assessment form could include:
Probability of host reading private data that should never be accessed
Probability of host breaking the policy on data preservation
Probability of host misusing a signature algorithm
Probability of host blocking migration
Probability of host diverting migration
Probability of host altering data or code elements
Probability of host providing a lower quality of service than the expected one
Probability of host not delivering the service it was paid for
Probability of host denying not having delivered a service it was paid for
Probability of host denying having delivered low quality of service
Probability of being unable to trace back host's actions

This can be achieved in a variety of ways, for example by examining the data retrieved by the various agents from the hosts to determine if there are any differences with agents using different routes. Examining the returned agents themselves to see if they have been altered in any way other than in terms of their retrieved data—this might include blocking or changing a migration route. The agents might contain a temporary email address to determine if Spam emails then start arriving at this after a couple of days. If this occurs then one of the hosts will have violated its policy and read private data in the agent. The level of differences, alternatives and/or whether Spam is received may be used to provide a trust level or parameter for the or a number of hosts.

Preferably the assessment agent will carry information such as id information, email, signatures and public certificates, and so on. These details will correspond to temporary entities that a mobile platform might be able to set up in a legal manner. For example the creator of an assessment agent might want to set up a temporary email address in advance as well as request from a public certificate authority to be granted a certificate that will be temporarily used for specific assessment purposes. This certificate need not allow an agent to perform any transaction automatically since it will be temporary. However the target platforms will not be aware of this and should believe that the agent will be equipped with these utilities and hence is just another normal commerce agent that could potentially decide to complete a transaction.

The embodiments offer a very responsive, reliable and low overhead security service to end terminals (clients); essentially a new market is now available for this service. The service can be tailored to different price brackets, the more extensive the assessment process and the more accurate the assessment results the greater the price (without any further burden to the end terminal).

Assessments of “security quality” can then be further exploited by other applications in order to adapt their security to the existing circumstances as well as control the overall risk in a fine-grained manner. The assessment agent system is highly scalable and it can provide security assessments of high precision and low risk analyses. As a result the system is ideal for large scale security tests that can be run by service providers such as Assessment Agency specialist software providers.

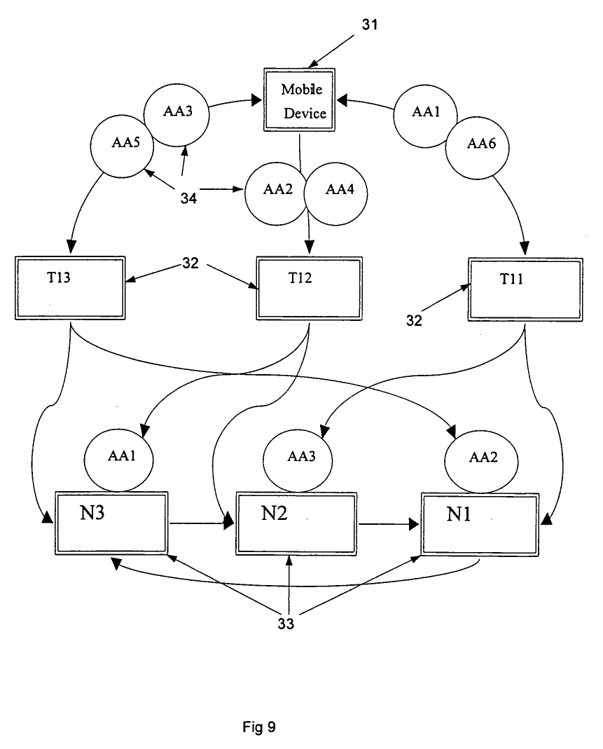

A preferred distributed routing arrangement for use with an assessment agent system is illustrated in FIG. 9. In this case a mobile device 31 wishes to “security” test three target platforms or node 33(N1), 33(N2), 33(N3). This is done using three trusted platforms 32(T11), 32(T12), 32(T13) that the mobile device 31 employs in order to set up its distributed routing strategy as well as provide to the mobile device 31 anonymity.

Six mobile assessment agents 34(AA1-AA6) are instantiated. These are separated into two groups of three. The first three agents AA1-AA3 attempt to fetch as much information as possible related to their target platforms' creditability. These three agents start their journey from a distinct trusted platform (eg AA3 from 32(T13)) and then migrate to two target platforms each (eg 33(N1) and 33(N3)). They symmetrically start from a distinct target platform (N1 and N3) and end up in another target platform (N3 and N2) where they will not have instructions on where to go next.

The second group of three agents AA4-AA6 start from distinct trusted platforms (eg AA5 from T13) and visit the respective platforms (N3 and N1) where the other agents (AA2 and AA3) are waiting idle. These later agents AA4-AA6 then either take the waiting agents (AA1-AA3) back with them to the trusted platforms 32, or provide the waiting agents AA1-AA3 with further migration information.

In a more detailed example, assessment agent AA3 sets off from trusted platform T13, it visits target platform N1, it then migrates to target platform N3 and then waits to meet with guidance assessment agent AA4 (coming from trusted platform T12). Similarly assessment agent AA2 starts from trusted platform T12, migrates to target platform N2, then target platform N1 and waits for further instructions from guidance assessment agent AA5 coming from trusted platform T13. In a symmetrical fashion agent AA1 will wait for its guidance in platform N12 from agent AA6.

Guidance instructions might simply include: agent AA1 instructed to return to trusted platform T12, agent AA2 to return to trusted platform T13 and agent AA1 to return to trusted platform T11. The means for achieving this are well known, for example as provided by FIPA, the interaction being provided through the mechanism of agent requests to the common host, these being carried out in the host's secure area. For example two agents might carry signed identification/authentication tokens such as digital certificates (e.g. SLL digital certificates issued by VeriSign™, which could have all the services that the public-key infrastructure X.509 defines—see security working group of www.ietf.org) in order to authenticate each other, they can then interact by exchanging data via a virtual channel within their host.

To avoid making the target hosts suspicious, all the agents should be completely uncorrelated In other words agents should not include information about each other such as the other agent's id or email information, or information about what happens when an agent migrates to its final (trusted) platform. Preferably the routing information that the assessment agents carry should have as few common migration paths as possible. The migration paths include all the chain of platforms that an agent will visit during its life (starting from a trusted platform). Thus assessment agents that pass through one target platform should not have (or should minimise) migration chains that will have common elements in order minimise the likelihood that the target platform might be able to link the two agents. Also the trusted platforms 32 could for simplicity be the very same mobile terminal 31, a home computer, or preferably random public servers hired for the purpose (this might come at an increased cost).

By using the second set of agents AA4-AA6 as guidance only for the first set AA1-AA3, the agent's anonymity is increased by removing from it its future migration logic. These mobile agent routes are symmetrical in order to distribute evenly the amount of clues agents give about their identity to all three target platforms, however these routes may be asymmetrical.

By minimising the likelihood of the target platforms getting suspicious and therefore increasing the likelihood of them demonstrating their genuine behaviour, this protocol architecture enables safer and more assured security assessments of the target nodes. For example if we find out that only agent AA1 and AA2 have been tampered with, then since agent AA1 went thought targets N1 and N3 and agent AA2 went through targets N2 and N1, it seems that it is target N1 is the more likely to have misbehaved.

It is preferred to direct the assessment agents through two or more target hosts rather than just one. Otherwise, when a target host receives an agent that persists in migrating to an unknown server (without migrating for example to a known competitor), it will have a good reason to refrain from behaving badly (either because it believes that this incoming agent might be an assessment agent or it can't see any direct competition). Thus a normally misbehaving server or target platform might decide to demonstrate an excellent character and subsequently the evaluation results will differ significantly from the objective of an accurate prediction. For example the server might otherwise not react similarly when for example the incoming agent requests to migrate to a well-known rival service provider. On top of that the mobile device will not be able to repeat assessment procedures because then the host will assign a high probability to these incoming agents being assessment agents, assuming that it keeps records of past events and makes statistical analyses and comparisons.

By using multiple agents, the gathered information can be cross-referenced, and more accurate predictions made. Furthermore, this avoids the problem of having to trust the second target platform to provide genuine information of what happened to the agent, or to just send the agent back without tampering with it. On the other hand, if normally and without delay, an agent that looks integral is returned, then it can be assumed that both target platforms should have behaved properly.

A further advantage of the assessment strategy is that if an agent dies or is revealed, this does not greatly affect the effectiveness of the system. This is because only the platform 32 that sent the agent 34 will likely have more difficulty in passing assessment agents around as normal agents next time. The other trusted platforms should be unaffected.

The very existence of assessment agents may additionally have the advantage of forcing service provider platforms 32 to behave properly, especially if they are unable to distinguish between assessment agents and normal e-commerce agents.

Examples of distributed programming infrastructures on which the mobile agents could be implemented included CORBA (OMG), JXTA (SUN), Microsoft.NET and any abstract server with any abstract Operating System with any abstract software Mobile Agent Platform module that will adhere to interoperable specifications such as the ones defined by FIPA.

The skilled person will recognise that the above-described apparatus and methods may be embodied as processor control code, for example on a carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional programme code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

The skilled person will also appreciate that the various embodiments and specific features described with respect to them could be freely combined with the other embodiments or their specifically described features in general accordance with the above teaching. The skilled person will also recognise that various alterations and modifications can be made to specific examples described without departing from the scope of the appended claims.

1. A trust assessment system for assessing a target node in a network having a number of nodes, the system comprising:
a plurality of trusted nodes coupled to said network
an assessment node coupled to said trusted nodes and comprising means for issuing a plurality of software agents for assessing said target node to said trusted nodes;
each said trusted node having means for receiving an agent from the assessment node and means for modifying the received agent by changing a source identifier associated with said assessment node in the agent to a source identifier associated with said trusted node;
means for forwarding said modified agent onto said network to said target node.

2. A system according to claim 1 said trusted nodes further comprising:
means for adding a final destination identifier associated with another said trusted node into the modified agent, and means for sending a notification to said other trusted node.

3. A system according to claim 2 wherein said trusted node further comprises:
means for receiving a notification from another trusted node; and
means for receiving a modified agent having a final destination identifier associated with said trusted node;
means for further modifying said agent by changing said final destination identifier to an identifier associated with said assessment node; and
means for forwarding said further modified agent to said assessment node.

4. A system according to claim 2 wherein said notification comprises one or more of: an identifier associated with the notification sender; a time of forwarding said modified agent; a modified agent identifier.

5. A system according to claim 1 wherein a first group of said assessment agents are arranged to request data from said target node.

6. A system according to claim 5 wherein a second group of said assessment agents are arranged to interact with assessment agents from said first group on said target nodes.

7. A system according to claim 5 wherein said assessment node further comprises means for receiving said modified assessment agents following said data requesting, and means for analysing said retrieved target node data in order to determine a trust level or parameter for said target node.

8. A system according to claim 1 wherein said assessment agents comprise one or more of the following identifiers associated with a virtual person: an email address; bank details; name; phone number; address; security certificate.

9. A system according to claim 1 wherein said assessment agents comprise a sequence of routing identifiers each corresponding to one of a number of said target nodes.

10. A system according to claim 9 wherein the assessment node is arranged to provide the agents with different sequences of said routing identifiers.

11. A system according to claim 9 wherein the assessment node is arranged to provide the agents with different routing identifiers.

12. A trusted node for a trust assessment system for assessing a target node in a network having a number of nodes, the trusted node comprising:
means for receiving from an assessment node a software agent for assessing said target node;
means for modifying the received agent by changing a source identifier associated with said assessment node in the agent to a source identifier associated with said trusted node;
means for forwarding said modified agent onto said network to said target node.

13. A node according to claim 12 further comprising means for adding a final destination identifier associated with another trusted node into the modified agent, and means for sending a notification to said other trusted node.

14. A trusted node for a trust assessment system for assessing a target node in a network having a number of nodes, the trusted node comprising:
means for receiving a notification from another trusted node;
means for receiving a software agent having a final destination identifier associated with said trusted node;
means for modifying said agent by changing said final destination identifier to an identifier associated with an assessment node; and
means for forwarding said modified agent to said assessment node.

15. A method for assessing a target node in a network having a number of nodes including a plurality of trusted nodes coupled to said network; the method comprising:
issuing a plurality of software agents for assessing said target node to said trusted nodes;
modifying the received agent by changing a source identifier associated with the origin of the agent to a source identifier associated with said trusted node;
forwarding said modified agent onto said network to said target node.

16. A method according to claim 15 further comprising:
adding a final destination identifier associated with another said trusted node into the modified agent, and sending a notification to said other trusted node.

17. A method according to claim 16 further comprising:
receiving a notification from another trusted node; and
receiving a modified agent having a final destination identifier associated with said trusted node; and
further modifying said agent by changing said final destination identifier to an identifier associated with an assessment node; and
forwarding said further modified agent to said assessment node.

18. A method according to claim 16 wherein said notification comprises one or more of: an identifier associated with the notification sender; a time of forwarding said modified agent; a modified agent identifier.

19. A method according to claim 15 wherein a first group of said assessment agents are arranged to request data from said target node.

20. A method according to claim 19 wherein a second group of said assessment agents are arranged to interact with assessment agents from said first group on said target nodes.

21. A method according to claim 19 further comprising receiving said modified assessment agents following said data requesting, and analysing said retrieved target node data in order to determine a trust level or parameter for said target node.

22. A method according to claim 15 wherein said assessment agents comprise one or more of the following identifiers associated with a virtual person: an email address; bank details; name; phone number; address; security certificate.

23. A method according to claim 15 wherein said assessment agents comprise a sequence of routing identifiers each corresponding to one of a number of said target nodes.

24. A method according to claim 23 wherein agents comprise different sequences of said routing identifiers.

25. A method of operating a trusted node for a trust assessment system for assessing a target node in a network having a number of nodes, the method comprising:
receiving from an assessment node a software agent for assessing said target node;
modifying the received agent by changing a source identifier associated with said assessment node in the agent to a source identifier associated with said trusted node;
forwarding said modified agent onto said network to said target node.

26. A method according to claim 25 further comprising adding a final destination identifier associated with another trusted node into the modified agent, and sending a notification to said other trusted node.

27. A method of operating a trusted node for a trust assessment system for assessing a target node in a network having a number of nodes, the method comprising:
receiving a notification from another trusted node;
receiving a software agent having a final destination identifier associated with said trusted node;
modifying said agent by changing said final destination identifier to an identifier associated with an assessment node; and
forwarding said modified agent to said assessment node.

28. Processor control code which when implemented on a processor is arranged to carry out a method according to claim 15.
